(19) United States
(12) Patent Application Publication
(10) Pub. No.: US 2006/0178443 A1
(43) Pub. Date: Aug. 10, 2006

(54) Nanoparticles for the production of polyurethane foam

(76) Inventors: Tammo Boinowitz, Essen (DE); Ruediger Landers, Essen (DE); Hans-Heinrich Schloens, Essen (DE)

Correspondence Address: FROMMER LAWRENCE & HAUG, 745 FIFTH AVENUE- 10TH FL., NEW YORK, NY, 10151, US

(21) Appl. No.: 11/336,090

(22) Filed: Jan. 20, 2006

(30) Foreign Application Priority Data
Jan. 24, 2005 (DE) 10 2005 003 299.0

(51) Int. Cl. C08J 9/00

(52) U.S. Cl. 521/99

(57) ABSTRACT

The invention relates to a nucleating agent for the production of polyurethane foam comprising nanoparticles, a polyurethane foam comprising nanoparticles, the use of the nucleating agent for producing the polyurethane foam, a method of controlling the cell structure using the nucleating agent, a process for producing the polyurethane foam and a system for carrying out the process comprising separate individual components.

Nanoparticles for the production of polyurethane foam Any foregoing applications, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Citation or identification of any document in this application is not an admission that such document is available as prior art to the present invention.

Terms “comprising” and “comprises” in this disclosure can mean “including” and “includes” or can have the meaning commonly given to the term “comprising” or “comprises” in US Patent Law. Terms “consisting essentially of” or “consists essentially of” if used in the claims have the meaning ascribed to them in US Patent Law. Other aspects of the invention are described in or are obvious from (and within the ambit of the invention) the following disclosure.

The invention relates to a nucleating agent for the production of polyurethane (PU) foam comprising nanoparticles, a polyurethane foam comprising nanoparticles, the use of the nucleating agent for producing the polyurethane foam, a method of controlling the cell structure using the nucleating agent, a process for producing the polyurethane foam and a system for carrying out the process comprising separate individual components.

For the purposes of the present invention, nanoparticles are particles having a particle size which is smaller than one micron. Nanoparticles are already being used for various applications. Thus, they are utilized as additives in the surface coatings industry for increasing the hardness/scratch resistance without influencing the transparency. In addition, formation of nanoparticles often results in maintaining the properties of the larger particle form, e.g. titanium dioxide nanoparticles retains antimicrobial activity. Zinc oxide and titanium dioxide nanoparticles continue to be useful for the UV protection.

Nanotechnology, i.e. the study and utilization of structures in the nanometer size range has long time been relevant for the field of production of PU foams.

Firstly, the substructure of polyurethanes is very often heterogeneous on a nanometer scale (phase separation in hard and soft segments). Analytical methods of nanotechnology (e.g. atomic force microscopy) are widely used for analysis here.

Secondly, nanoparticles have also already been used as fillers for PU foam in a manner analogous to the widespread microparticle fillers. When microparticles are used, it has been found that the cell structure becomes finer at high concentrations of the microparticles (typically 5-20% by weight). The addition of these high concentrations of microparticles often causes changes in the mechanical properties (hardness, elasticity) of the PU foam. These changes are often undesirable (e.g. lower elasticity). Specific nanoparticles, specifically intercalated sheet silicates), too, have repeatedly been used in PU foam. No significantly higher cell density has been observed here.

Nanoparticles have hitherto been mixed with other components such as stabilizers and the remaining starting materials for the production of polyurethane foam. When conventional nucleating agents (e.g. polymer polyols or mineral microparticles) are used, only a slight increase in the fineness of the cell structure (less than 20% more cells per cm) has hitherto been observed, or high concentrations have had to be used.

Known particulate nucleating agents for PU foam have had to be present in amounts typically of at least 10% by weight in the polyurethane foam in order to have a significant effect on the cell structure. The use of nucleating agents (including nanoparticles) is, however, widespread in the extrusion of melts of gas-laden thermoplastic polymers.

However, this process is not comparable with foaming of PU. In one case thermoplastic polymers are foamed by means of an external blowing agent in a purely physical process, while in the production of a PU foam, a chemical reaction leads to formation of a thermoset polymer network. The most important blowing agent is in this case the carbon dioxide formed by reaction of water with the isocyanate. Here, the formation of a PU foam places different demands on a nucleating agent.

X. Han et al. refers to polystyrene nanocomposites and foams composed of these in their article in Polymer Engineering and Science, June 2003, Vol. 43, No. 6, pages 1261-1275. These foams are obtained by foaming a mixture of polystyrene and nanoparticles by coextrusion. The cell size is reduced slightly by about 14% as a result of the presence of the nanoparticles.

In the chapter “Energy-Absorbing Multikomponent Interpenetrating Polymer Network Elastomers and Foams” of the book “Multiphase Polymers: Blends and Ionomers”, American Chemical Society, 1989, D. Klempner et al. refers to composites of polyurethane foam and graphite microparticles on pages 263 to 308.

In their article in Journal of Cellular Plastics, Vol. 38, May 2002, pages 229 to 240, I. Javni et al. refers to composites of polyurethane foam and SiO₂ nanoparticles in which the proportion by weight of the nanoparticles is at least 5% by weight.

In their article in the Conference Proceedings—Polyurethanes Expo, Columbus, Ohio, United States, Sept. 30-Oct. 3, 2001 (2001), 239-244 (Publisher: Alliance for the Polyurethanes Industry, Arlington, Va.), B. Krishnamurthi et al. refers to composites of polyurethane form and clusters in which at least 5% by weight of clusters, based on the polyol used, is employed. The clusters were in the micron range but were made up of nanoparticles. The nanoparticles are sheet silicates.

WO 03/059817 A2 refers to composites of polyurethane foam and nanoparticles in which the proportion of the nanoparticles is at least 2.5% by weight.

US 2003/0205832 A1 refers to composites of polyurethane foam and nanoparticles in which, however, the cell count per cm increases only by about 26% as a result of the use of the nanoparticles.

EP 0857740 A2 refers to composites of polyurethane foam and microparticles.

WO 01/05883 A1 refers to composites of polyurethane-based elastomer and nanoparticles.

U.S. Pat. No. 6,121,336 A refers to composites of polyurethane foam and microparticles comprising SiO₂ aerogels.

RU 2182579 C2 refers to magnetic composites comprising foams and magnetic nanoparticles, in which the proportion of the nanoparticles is at least 2% by weight.

EP 1209189 A1 refers to composites of polyurethane foam and nanoparticles comprising SiO₂.

It is an object of the invention to produce a significantly finer cell structure of polyurethane foams by use of very small amounts of nucleating agents without significantly changing the mechanical properties of the PU foam.

In a first embodiment, this object is achieved by a nucleating agent for the production of polyurethane foam, which comprises
a) from about 0.5 to about 60% by weight of nanoparticles having an average diameter in the range from about 1 to about 400 nm, preferably from about 1 to about 200 nm,
b) from about 0.5 to about 99.5% by weight of dispersant, and
c) from 0 to about 99.0% by weight of solvent,
   in each case based on the total weight of the nucleating agent.

A significant cell refinement (increase in the fineness of the cells) has surprisingly been able to be observed as a result of the use of the nucleating agent of the invention. Despite the use of only from about 0.01 to about 5% by weight of nucleating agent, based on all starting materials for the polyurethane foam, it was possible to produce >70%, usually even >90%, more cells per cm in polyurethane foams.

The significantly greater activity of the nanoparticles can also be observed in a direct comparison of calcium carbonate microparticles with a dispersion of Aerosil® Ox 50 nanoparticles which is depicted in FIGS. 1-4. Even very small amounts of nanoparticle dispersions (from 0.5 to 1.0 part by weight) lead to drastically finer foams. 2 cell refinement additives are compared in the accompanying figures. In the case of the nanoparticles, a 30% dispersion is used. The calcium carbonate (Fluka, average particle size: about 1.5 micron) is used in pure form. Based on the amount of solid used, the activity of the nanomaterial is thus about 3× higher, as is shown by the figures presented.

For the purposes of the invention, a nucleating agent is an additive which favors nucleation of gas bubbles and foam cells in the production of polyurethane foam. On the other hand, in the processing of unfoamed thermoplastics, nucleating agents result in an increase in the temperature at which crystallization of the melt commences, an increase in the growth rate of the spherolites and the crystalline fraction and a reduction in the spherolite size.

Nucleating agents used are usually insoluble inorganic fillers such as metals, metal oxides, metal salts, silicates, boron nitrides or other inorganic salts which can also be used according to the invention. In the case of the physically foamed thermoplastic polymers, nanoparticle dispersions cannot be used because of technical circumstances (high temperature, high viscosity). Instead, nanoparticles can be used here in a manner analogous to the nanoparticle dispersions. However, in the polyurethane foam, undispersed nanoparticles display a relatively low activity, which is confirmed by the references mentioned above.

The use of the nucleating agent of the invention surprisingly also leads to significantly lower yellowing of the resulting foam when it is exposed to UV radiation.

Furthermore, the use of the nucleating agent of the invention can have an influence on the burning behavior of the PU foam. Here, selected nanoparticles give improved fire protection. Particular preference is given to using aluminum oxides for this purpose.

In contrast to the state of the art, a very significant refinement of the cell structure (from about 10 cells/cm to 18 cells/cm) has surprisingly been observed even at very small amounts of preferably up to 30% strength by weight nanoparticle dispersions (the nucleating agent).

The proportion of nanoparticles in the nucleating agent is preferably from about 25 to about 35% by weight, particularly preferably about 30% by weight, based on the weight of the nucleating agent.

The proportion of nanoparticles in the nucleating agent is advantageously set so that the resulting PU foam contains from about 0.01 to about 5% by weight, in particular from 0.01 to 1% by weight, preferably from about 0.25 to about 0.7% by weight, of nanoparticles, based on the weight of the foam.

This refinement is, in view of the small amount used (preferably less than about 1.0% of nanoparticles based on the weight of the foam, more preferably about 0.6% of nanoparticles based on the weight of the foam), greater than all cell refinements hitherto observed as a result of other additives. In addition, the significance of the change (about 80-100% more cells per cm) is very unusual.

In contrast to the nanoparticles used in the state of the art, a dispersant is additionally used according to the invention. Here, the effect has been observed both when using a dispersion of the nanoparticles in pure dispersant and also in a mixture of dispersant and solvent (e.g. water). The dispersant can thus advantageously also be identical to the solvent. The use of the dispersant obviously brings about very fine and stable dispersion of the nanoparticles. Otherwise, there is formation of agglomerates whose activity is very much lower in PU foaming.

Comparable effects have been observed when using nanoparticles comprising, for example, metal oxide, particularly preferably silicon dioxide, zinc oxide, aluminum oxide (basic) aluminum, oxide (neutral), zirconium oxide and titanium oxide.

For the purposes of the invention, nanoparticles are preferably not sheet silicates, since these greatly increase the viscosity of the nucleating agent and the nucleating agent can therefore contain only a small proportion of nanoparticles before it becomes too paste-like and thus can no longer be used for the production of polyurethane foam. Nanoparticles of carbon black did not display as strong an effect as nanoparticles of metal oxides and lead to discoloration of the foam. The nanoparticles of the invention therefore preferably do not comprise carbon blacks and/or black pastes. The heterogeneity introduced by the nanoparticles in combination with a large surface area (small particle size) appears to be of central importance. The effect of the nanoparticles may be attributed to improved nucleation/nucleus formation.

The nucleating agent is advantageously free of conventional PU foam stabilizers so that the nanoparticles can be dispersed better.

The average particle diameter of the primary particles of the nanoparticles used according to the invention is preferably in the range from about 10 to about 200 nm (an example of this can be seen in FIG. 5 which depicts the mass average size distribution of the nanoparticles of Aerosil® Ox50 in aqueous solution), preferably in the range from about 10 to about 50 nm. The objective of the use of dispersants in separate nanoparticle dispersions is to come as close as possible to this low primary particle diameter during dispersion and to stabilize the nanoparticle dispersion.

Apart from the use of a suitable dispersant, the introduction of shear energy into the nanoparticle dispersion is also advantageous in order to achieve the desired fine dispersion of the nanoparticles in the dispersant or in the mixture of dispersant and solvent. The nanoparticles of the nucleating agent are thus preferably partly, predominantly or in particular completely deagglomerated.

A variety of dispersion apparatuses are available to those skilled in the art for producing the nanodispersions. In the simplest case, dispersion of the nanoparticles is achieved by introduction of shear energy in Dispermats and the effectiveness of the selected dispersant can be seen by the decrease in the viscosity of the nanodispersion. In the laboratory, 10-hour dispersion in a Scandex® LAU Disperser DAS 200 from LAU GmbH has been found to be particularly efficient for screening. The large-scale industrial manufacture of the nanodispersions is in practical terms carried out by means of Ultraturrax, bead mill or, to obtain particularly fine dispersions, a wet jet mill. The above listing of dispersion principles does not claim to be exhaustive and therefore does not constitute a restriction to these methods by means of which the nanodispersions as nucleating agents to be used in polyurethane foams are produced.

The distinction between dispersant/emulsifier on the one hand and PU foam stabilizer on the other hand is important. Both groups of substances encompass surface-active surfactants. While dispersants/emulsifiers typically have a polymeric backbone with groups which have an affinity with and preferentially interact with the nanoparticles and additionally achieve compatibility to the surrounding matrix by means of organic side chains or have a surfactant, low molecular weight structure, i.e. have a hydrophile-lipophile balance in the essentially linear structure in which particular blocks of the molecule have an attraction for nanoparticles of this type, stabilizers for PU form are of a different chemical nature and can typically be characterized as polyether siloxanes. Such polyether siloxanes have no specific affinity to the nanoparticle and, in complete contrast to dispersants, produce controlled incompatibility. The nanoparticles can preferably also be stabilized other than with dispersants by matching of the zeta potential, the pH and the charge on the surface of the nanoparticles. For these reasons, the state of the art shows no appreciable effect when using nanoparticles in polyurethane foams in the presence of stabilizers.

According to the invention, preference is given to dispersions of the nanoparticles in protic or aprotic solvents or mixtures thereof, which includes but is not limited to water, methanol, ethanol, isopropanol, polyols (for example ethanediol, 1,4-butanediol, 1,6-hexanediol, dipropyleneglycol, polyetherpolyols, polyesterpolyols), THF, diethylether, pentane, cyclopentane, hexane, heptane, toluene, acetone, 2-butanone, phthalates, butyl acetate, esters, in particular triglycerides and vegetable oils, phosphoric esters, phosphonic esters, also dibasic esters, or dilute acids such as hydrochloric acid, sulfuric acid, acetic acid or phosphoric acid, particularly preferably in a polyol. Liquefied or supercritical carbon dioxide can also be used as solvent. Particularly preferred solvents are ionic liquids such as VP-D102 or LA-D 903 from Tego Chemie Service GmbH and/or water. When ionic liquids are used on their own without an additional solvent, the group of substances also assumes the function of the dispersant.

Ionic liquids are salts which melt at low temperatures (<100° C.) and represent a new class of liquids having a nonmolecular, ionic character. In contrast to classical salt melts, which are high-melting, highly viscous and very corrosive media, ionic liquids are liquid at a relatively low temperature and have a relatively low viscosity (K. R. Seddon J. Chem. Technol. Biotechnol. 1997, 68, 351-356).

Ionic liquids comprise anions which includes but is not limited to halides, carboxylates, phosphates, alkylsulfonates, tetrafluoroborates or hexafluorophosphates combined with cations which include but is not limited to substituted ammonium, phosphonium, pyridinium or imidazolium cations. The anions and cations mentioned are only a small selection from the large numbers of possible anions and cations and thus make no claim to completeness and do not constitute any restriction.

The abovementioned ionic liquids LA-D 903 from the group of imidazolinium salts and VP-D 102 from the group of alkoxyquats are therefore merely examples of particularly effective components.

Dispersants are known to those skilled in the art, for example under the terms emulsifiers, protective colloids, wetting agents and detergents. If the dispersant is different from the solvent, the nucleating agent of the invention preferably contains from about 1 to about 45% by weight, in particular from about 2 to about 10% by weight, of dispersant, very particularly preferably from about 4 to about 5% by weight of dispersant.

Many different substances are dispersants for solids. Apart from very simple, low molecular weight compounds, e.g. lecithin, fatty acids and their salts and alkylphenol ethoxylates, more complex high molecular weight structures are also used as dispersants. Low molecular weight dispersants include but are not limited to, liquid acid esters such as dibutyl phosphate, tributyl phosphate, sulfonic esters, borates or derivatives of silicic acid, for example tetraethoxysilane, methyltrimethoxysilane, 3-aminopropyltrimethoxysilane, 3-aminopropyltriethoxysilane, glycidyloxypropyltrimethoxysilane, or glycidyloxypropyltriethoxysilane, are often used according to the prior art. Among high molecular weight dispersants, it is especially amino- and amido-functional systems which are widely used. U.S. Pat. No. 4,224,212 A, EP-0 208 041 A, WO-00/24503 A and WO-01/21298 A describe, for example, dispersants based on polyester-modified polyamines. DE-197 32 251 A describes polyamine salts and their use as dispersants for pigments and fillers. Maleic anhydride copolymers containing amine oxide groups and their use as dispersants for pigments or fillers are described by EP 1026178 A. Polyacrylic esters which have acidic and/or basic groups, which may also be in salt form, and can be prepared by polymerization of corresponding monomeric acrylic esters, for example butyl acrylate, acrylic acid, 2-hydroxyethyl acrylate and their alkoxylation products and other monomers having vinylic double bonds, e.g. styrene or vinylimidazol, are used (cf., for example, EP 0 311 157 B).

However, there are also descriptions of how such dispersants can be produced by means of transesterification reactions on polyalkyl acrylates by replacement of the alkyl group by alcohols or amines in a polymer-analogous reaction (cf. for example, EP 0 595 129 B, DE 39 06 702 C, EP 0 879 860 A).

Furthermore, phosphoric esters and their use as dispersants are also known. U.S. Pat. No. 4,720,514 A describes phosphoric esters of a series of alkylphenol ethoxylates which can advantageously be used for formulating aqueous pigment dispersions. U.S. Pat. No. 6,689,731 B2 describes phosphoric esters based on polystyrene-block-polyalkylene oxide copolymers as dispersants. Phosphoric esters for a similar application are described in EP 0 256 427 A. Biphosphoric monoesters of block copolymers and salts thereof are known from DE 3 542 441 A. Their possible use as dispersants and emulsifiers is also described. U.S. Pat. No. 4,872,916 A describes the use of phosphoric esters based on alkylene oxides of straight-chain or branched aliphatics as pigment dispersants. In the same way, the use of corresponding sulfates is mentioned in U.S. Pat. No. 3,874,891 A. Tertiary amines and quaternary ammonium salts, which may additionally have catalytic activity in respect of the chemical reactions occurring in the formation of the polyurethane foam, can also be used as dispersants. Furthermore, the dispersants used can themselves also have an influence on foam formation. This influence can comprise a stabilizing action, a nucleating action, an emulsifying action on the starting materials for the PU foam, a cell-opening action or an action in respect of the uniformity of the foam in outer zones.

Particularly preferred dispersants are VP-D 102, LA-D 903, Tego® Dispers 752W, Tego® Dispers 650, Tego® Dispers 651, etc., with all the abovementioned products coming from the catalogue of Tego Chemie Service GmbH.

All the abovementioned dispersants can also be used for the purposes of the present invention.

The nanoparticles can, in a further embodiment, also be added directly to the polyol used in PU foaming. The nanoparticles can thus be added directly to the entire amount used or part of one of the main reactants in the production of polyurethane foam. The dispersant can be added separately or together with the nanoparticles.

Addition of the dispersed nanoparticles (with dispersant) to the stabilizer is also possible, but less preferred since this would result in a further increase in the viscosity of the already relatively highly viscous stabilizer. In addition, it would then no longer be possible to independently set stabilization (via the amount of stabilizer) and cell size (via the amount of nanoparticle dispersion).

Addition of the nanoparticle dispersion to the isocyanate appears less advisable owing to the reactivity of the isocyanate, although it is also possible.

In another embodiment of the invention, the nanoparticle dispersion is added to a flame retardant.

In a further embodiment, the object of the invention is achieved by a polyurethane foam which has a cell count of at least about 10, preferably about 15, cells cm⁻¹ and contains from about 0.01 to about 5% by weight of nanoparticles having an average diameter in the range from about 1 to about 400 nm. The cell count can be determined manually by means of a magnifying glass provided with a scale. Here, the cells are counted in three different places and averaged. As an alternative, the foam surface is colored by means of a black felt-tipped pen (only the uppermost layer of cells), an image is recorded on a flat-bed scanner and this is then examined using an image analysis program. Here, a euclidic distance transformation and a Wasserscheid reconstruction are carried out. Image analysis software gives the mean Feret diameter of the cells from which the cell count can be calculated. The two methods of determination often give slightly different values (typically a difference of from about 0 to 2 cells).

The polyurethane foam of the invention advantageously contains from about 0.01 to about 1% by weight, preferably from about 0.15 to about 0.80% by weight, more preferably from about 0.24 to about 0.72% by weight, of nanoparticles.

The size of the nanoparticles is advantageously determined by dynamic light scattering. Such methods are known to those skilled in the art. The accompanying FIG. 5 shows the mass weighted size distribution of the nanoparticles Aerosil® Ox50 in aqueous solution with the emulsifier Tego® Dispers 752W (used in Example 5). It can be seen that the size distribution is bimodal: in addition to a relatively small peak for the free primary particles (from about 40 to about 50 nm), many aggregates having a significantly larger diameter (from about 100 to about 200 nm) are also present. Both free primary particles and the aggregates in the nanometer range are relevant for producing the effect according to the invention.

The polyurethane foam of the invention is preferably a flexible foam (based on either polyether polyols or polyester polyols), a rigid foam (based on either polyether polyols or polyester polyols) or a microcellular foam. Furthermore, the polyurethane foam can be in the form of a slabstock foam or a molded foam.

The polyurethane foam of the invention is particularly preferably a flexible foam. This can be a hot-cured foam, a viscoelastic foam or an HR (high-resilience or cold-cured) foam. On being subjected to pressure, flexible foam has a relatively low deformation resistance (DIN 7726). Typical values for the compressive stress at 40% compression are in the range from about 2 to about 10 kPa (procedure in accordance with DIN EN ISO3386-½). The cell structure of the flexible foam is mostly open-celled. The density of the polyurethane foam of the invention is preferably in the range from about 10 to about 80 kg/m³, in particular in the range from about 15 to about 50 kg/m³, very particularly preferably in the range from about 22 to about 30 kg/m³ (measured in accordance with DIN EN ISO 845, DIN EN ISO 823).

The gas permeability of the polyurethane foam of the invention is preferably in the range from about 0.1 to about 30 cm of ethanol, in particular in the range from about 0.7 to about 10 cm of ethanol (measured by measuring the pressure difference on flow through a foam specimen). For this purpose, a 5 cm thick foam disk is placed on a smooth surface. A plate (10 cm×10 cm) having a weight of 800 g and a central hole (diameter: 2 cm) and a hose connection is placed on the foam specimen. A constant air stream of 8 1/min is passed into the foam specimen via the central hole. The pressure difference generated (relative to unhindered outflow) is determined by means of an ethanol column in a graduated pressure meter. The more closed the foam, the greater the pressure which is built up and the greater the extent to which the surface of the column of ethanol is pushed downward and the greater the values measured.

In a further embodiment, the object of the invention is achieved by the use of the nucleating agent of the invention for producing polyurethane foam.

The nucleating agent of the invention is advantageously used for producing flexible foam.

In a further embodiment, the object of the invention is achieved by a method of controlling the cell structure of polyurethane foam, which comprises adding from about 0.01 to about 5% by weight of the above-defined nucleating agent, based on the total amount of the polyurethane foam, before or during the addition of diisocyanate in the production process for polyurethane foam, with the cell structure being controlled essentially by means of the amount of nucleating agent, the amount of dispersant in the nucleating agent and the amount and diameter of the nanoparticles in the nucleating agent.

In the method of the invention, it is advantageous to use from about 0.15 to about 4% by weight of the nucleating agent, based on the total amount of polyurethane foam.

In a further embodiment, the object of the invention is achieved by a process for producing polyurethane foam, which comprises:
a) mixing of 100 parts by weight of polyol, from about 0.2 to about 5 parts by weight of chemical blowing agent, from about 0.1 to about 5 parts by weight of stabilizer and from about 0.01 to about 5 parts by weight of the above-defined nucleating agent,
b) addition of from about 30 to about 70 parts by weight of isocyanate, and
c) mixing of the resulting composition.

It is advantageous to use from about 0.5 to about 1.5 parts by weight, in particular from about 0.5 to about 1 part by weight, of nucleating agent per 100 parts by weight of polyol.

Suitable polyols are ones which have at least two H atoms which are reactive toward isocyanate groups; preference is given to using polyester polyols and polyether polyols. Such polyether polyols can be prepared by known methods, for example by anionic polymerization of alkylene oxides in the presence of alkali metal hydroxides or alkali metal alkoxides as catalysts with addition of at least one starter molecule containing 2 or 3 reactive hydrogen atoms in bound form or by cationic polymerization of alkylene oxides in the presence of Lewis acids such as antimony pentachloride or boron fluoride etherate or by means of double metal cyanide catalysis. Suitable alkylene oxides have from 2 to 4 carbon atoms in the alkylene radical.

Examples include but are not limited to tetrahydrofuran, 1,3-propylene oxide, 1,2- or 2,3-butyleneoxide; preference is given to using ethylene oxide and/or 1,2-propylene oxide. The alkylene oxides can be used individually, alternately in succession or as mixtures. Starter molecules include but are not limited to water or 2- and 3-functional alcohols, e.g. ethylene glycol, 1,2- and 1,3-propanediol, diethylene glycol, dipropylene glycol, glycerol, trimethylolpropane, etc. Polyfunctional polyols such as carbohydrates can also be used as starter molecules.

The polyether polyols, preferably polyoxypropylene-polyoxyethylene polyols, have a functionality of from 2 to 3 and number average molecular weights in the range from about 500 to about 8000, preferably from about 800 to about 3500.

Suitable polyester polyols can, for example, be prepared from organic dicarboxylic acids having from 2 to 12 carbon atoms, preferably aliphatic dicarboxylic acids having from 4 to 6 carbon atoms, and polyhydric alcohols, preferably diols, having from 2 to 12 carbon atoms, preferably 2 carbon atoms. Dicarboxylic acids include, but are not limited to: succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids can be used either alone or in admixture with one another. In place of the free dicarboxylic acids, the corresponding dicarboxylic acid derivatives can be substituted, for example dicarboxylic monoesters and/or diesters of alcohols having from 1 to 4 carbon atoms or dicarboxylic anhydrides. Preference is given to using dicarboxylic acid mixtures of succinic acid, glutaric acid and adipic acid in ratios of, for example, about 20-35/about 35-50/about 20-32 parts by weight, and in particular adipic acid. Examples of dihydric and polyhydric alcohols include but are not limited to ethanediol, diethylene glycol, 1,2- or 1,3-propanediol, dipropylene glycol, methyl-1,3-propanediol, 1,4-butanediol, 1,5-pentanediol, 1,6-hexanediol, neopentyl glycol, 1,10-decanediol, glycerol, trimethylolpropane and pentaerythritol. Preference is given to using 1,2-ethanediol, diethylene glycol, 1,4-butanediol, 1,6-hexanediol, glycerol, trimethylolpropane or mixtures of at least two of the diols mentioned, in particular mixtures of ethanediol, 1,4-butanediol and 1,6-hexanediol, glycerol and/or trimethylolpropane. In another embodiment of the invention, the polyester polyols are derived from lactones, for example ε-caprolactone, or hydroxycarboxylic acids, for example o-hydroxycaproic acid and hydroxyacetic acid.

Stabilizers preferably encompass foam stabilizers based on polydialkylsiloxane-polyoxyalkylenecopolymers as are generally used in the production of urethane foams. These compounds generally have a structure in which, for example, a long-chain copolymer of ethylene oxide and propylene oxide is joined to a polydimethylsiloxane radical. The polydialkylsiloxane and the polyether part can be linked via an SiC bond or via an Si—O—C linkage. Structurally, the various polyethers can be bound terminally or laterally to the polydialkylsiloxane. The alkyl radical or the various alkyl radicals can be aliphatic, cycloaliphatic or aromatic. Methyl groups are very particularly advantageous. In a further very particularly advantageous embodiment, phenyl groups are present as radicals in the polyether siloxane. The polydialkylsiloxane can be linear or have branches.

Among these foam stabilizers, ones which generally have a relatively strong stabilizing action and are used for the formation of flexible, semirigid, and rigid foams are particularly useful.

As foam stabilizers for PU foams, mention may be made of, for example, L 620, L 635, L 650, L 6900, SC 154, SC 155 from GE Silicones or Silbyk® 9000, Silbyk® 9001, Silbyk® 9020, Silbyk® TP 3794, Silbyk® TP 3846, Silbyk® 9700, Silbyk® TP 3805, Silbyk® 9705, Silbyk® 9710 from Byk Chemie. Other appropriate foam stabilizers include but are not limited to BF 2740, B 8255, B 8462, B 4900, B 8123, BF 2270, B 8002, B 8040, B 8232, B 8240, B 8229, B 8110, B 8707, B 8681, B 8716LF from Goldschmidt GmbH.

Particular preference is given to the stabilizer BF 2370 from Goldschmidt GmbH.

In the process of the invention, preference is given to using from about 0.5 to about 1.5 parts by weight of stabilizer per 100 parts by weight of polyol.

As chemical blowing agent for producing the polyurethane foams, preference is given to using water which reacts with the isocyanate groups to liberate carbon dioxide. Water is preferably used in an amount of from about 0.2 to about 6 parts by weight, particularly preferably in an amount of from about 1.5 to about 5.0 parts by weight. Together with or in place of water, physically acting blowing agents may also be used which includes but is not limited to carbon dioxide, acetone, hydrocarbons such as n-pentane, isopentane or cyclopentane, cyclohexane, or halogenated hydrocarbons such as methylene chloride, tetrafluoroethane, pentafluoropropane, heptafluoropropane, pentafluorobutane, hexafluorobutane or dichloromonofluoroethane. The amount of physical blowing agent is preferably in the range from about 1 to about 15 parts by weight, in particular from about 1 to about 10 parts by weight, and the amount of water is preferably in the range from about 0.5 to about 10 parts by weight, in particular from about 1 to about 5 parts by weight. Among the physically acting blowing agents, preference is given to carbon dioxide which is preferably used in combination with water as chemical blowing agent.

Isocyanates include but are not limited to aliphatic, cycloaliphatic, araliphatic and preferably aromatic polyfunctional isocyanates. Particular preference is given to using isocyanates in such an amount that the ratio of isocyanate groups to isocyanate-reactive groups is in the range from about 0.8 to about 1.2.

Specific examples which may be mentioned include but are not limited to: alkylene diisocyanates having from 4 to 12 carbon atoms in the alkylene radical, e.g. dodecane 1,12-diisocyanate, 2-ethyltetramethylene 1,4-diisocyanate, 2-pentamethylene 1,5-diisocyanate, tetramethylene 1,4-diisocyanate and preferably hexamethylene 1,6-diisocyanate, cycloaliphatic diisocyanates such as cyclohexane-1,3- and 1,4-diisocyanate and also any mixtures of these isomers, 1-isocyanato-3,3,5-trimethyl-5-isocyanatomethylcyclohexane (IPDI), hexahydrotolylene 2,4- and 2,6-diisocyanate and also the corresponding isomer mixtures, dicyclohexylmethane 4,4′-, 2,2′- and 2,4′-diisocyanate and also the corresponding isomer mixtures, and preferably aromatic diisocyanate and polyisocyanates, for example tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. The organic diisocyanates and polyisocyanates can be used individually or in the form of their mixtures. Particular preference is given to mixtures of polyphenylpolymethylene polyisocyanate with diphenylmethane diisocyanate in which the proportion of diphenylmethane 2,4′-diisocyanate is preferably >30% by weight.

Modified polyfunctional isocyanates, i.e. products which are obtained by chemical reaction of organic diisocyanates and/or polyisocyanates, can also be used advantageously. Examples which may be mentioned include but are not limited to diisocyanates and/or polyisocyanates containing ester, urea, biuret, allophanate, carbodiimide, isocyanurate, uretdione and/or urethane groups. Specific examples are: modified diphenylmethane 4,4′-diisocyanate, modified diphenylmethane 4,4′- and 2,4′-diisocyanate mixtures, modified crude MDI or tolylene 2,4- or 2,6-diisocyanate, organic, preferably aromatic polyisocyanates which contain urethane groups and have NCO contents of from about 43 to about 15% by weight, preferably from about 31 to about 21% by weight, based on the total weight, for example reaction products with low molecular weight diols, triols, dialkylene glycols, trialkylene glycols or polyoxyalkylene glycols having molecular weights of up to about 6000, in particular molecular weights of up to about 1500, with these dialkylene or polyoxyalkylene glycols being able to be used individually or as mixtures. Examples which may be mentioned are: diethylene glycol, dipropylene glycol, polyoxyethylene, polyoxypropylene and polyoxypropylene-polyoxyethylene glycols, triols and/or tetrols. Also suitable are prepolymers which contain NCO groups and have NCO contents of from about 25 to about 3.5% by weight, preferably from about 21 to about 14% by weight, based on the total weight, and are prepared from the polyester polyols and/or preferably polyether polyols described below and diphenylmethane 4,4′-diisocyanate, mixtures of diphenylmethane 2,4′- and 4,4′-diisocyanate, tolylene 2,4- and/or 2,6-diisocyanates or crude MDI. Further modified isocyanates which have been found to be useful are liquid polyisocyanates which contain carbodiimide groups and/or isocyanurate rings and have NCO contents of from about 43 to about 15% by weight, preferably from about 31 to about 21% by weight, based on the total weight, for example ones based on diphenylmethane 4,4′-, 2,4′- and/or 2,2′-diisocyanate and/or tolylene 2,4- and/or 2,6-diisocyanate.

The modified polyisocyanates can be mixed with one another or with unmodified organic polyisocyanates such as diphenylmethane 2,4′-, 4,4′-diisocyanate, crude MDI, tolylene 2,4- and/or 2,6-diisocyanate.

Organic polyisocyanates which have been found to be particularly useful and are therefore preferably employed include but are not limited to tolylene diisocyanate, mixtures of diphenylmethane diisocyanate isomers, mixtures of diphenylmethane diisocyanate and polyphenylpolymethylene polyisocyanate or tolylene diisocyanate with diphenylmethane diisocyanate and/or polyphenylpolymethylene polyisocyanate or prepolymers. Particular preference is given to using tolylene diisocyanate in the process of the invention.

In a particularly preferred variant, mixtures of diphenylmethane diisocyanate isomers having a proportion of diphenylmethane 2,4′-diisocyanate of greater than about 20% by weight are used as organic and/or modified organic polyisocyanates.

Flame retardants, particularly ones which are liquid and/or soluble in one or more of the components used for producing the foam, may also be added to the starting materials. Preference is given to using commercial phosphorus-containing flame retardants, for example tricresyl phosphate, tris(2-chloroethyl) phosphate, tris(2-chloropropyl) phosphate, tris(2,3-dibromopropyl) phosphate, tris(1,3-dichloropropyl) phosphate, tetrakis(2-chloroethyl) ethylenediphosphate, dimethyl methanephosphonate, diethyl ethanephosphonate, diethyl diethanolaminomethylphosphonate. Halogen- and/or phosphorus-containing polyols having a flame-retardant action and/or melamine are likewise suitable. Furthermore melamine can also be used. The flame retardants are preferably used in an amount of not more than about 35% by weight, preferably not more than about 20% by weight, based on the polyol component. Further examples of surface-active additives and flame stabilizers and also cell regulators, reaction retarders, stabilizers, flame-retardant substances, dyes and fungistatic and bacteriostatic substances which may be concomitantly used and also details regarding the use and mode of action of these additives are described in G. Oertel (Editor) “Kunststoff-Handbuch”, volume VII, Carl Hanser Verlag, 3rd edition, Munich 1993, pp. 110-123.

Furthermore, from about 0.05 to about 0.5 part by weight, in particular from about 0.1 to about 0.2 part by weight, of catalysts can preferably be used for the blowing reaction in the process of the invention. These catalysts for the blowing reaction are selected from the group consisting of tertiary amines [triethylenediamine, triethylamine, tetramethylbutanediamine, dimethylcyclohexylamine, bis(2-dimethylaminoethyl) ether, dimethylaminoethoxyethanol, bis(3-dimethylaminopropyl)amine, N,N,N′-trimethylaminoethylethanolamine, 1,2-dimethylimidazole, N(3-aminopropyl)imidazole, 1-methylimidazole, N,N,N′,N′-tetramethyl-4,4′-diaminodicyclohexylmethane, N,N-dimethylethanolamine, N,N-diethylethanolamine, 1,8-diazabicyclo[5.4.0]undecene, N,N,N′,N′-tetramethyl-1,3-propanediamine, N,N-dimethylcyclohexylamine, N,N,N′,N″,N′″-pentamethyldiethylenetriamine, N,N,N′,N″,N′″-pentamethyldipropylenetriamine, N,N′-dimethylpiperazine, N-methylmorpholine, N-ethylmorpholine, bis(2-morpholinoethyl) ether, N,N-dimethylbenzylamine, N,N′,N″-tris(dimethylamino-propyl)hexahydrotriazine, N,N,N′,N′-tetramethyl-1,6-hexanediamine, tris(3-dimethylaminopropyl)amine and/or tetramethylpropanamine]. Acid-blocked derivatives of the tertiary amines are likewise suitable. In a particular embodiment, dimethylethanolamine is used as amine. In a further embodiment, triethylenediamine is used as amine.

From about 0.05 to about 0.5 part by weight, in particular from about 0.1 to about 0.3 part by weight, of catalysts for both the gelling reaction and the trimerization reaction can also preferably be used in the process of the invention. The catalysts for the gelling reaction are selected from the group consisting of organometallic compounds and metal salts of the following metals: tin, zinc, tungsten, iron, bismuth, titanium. In a particular embodiment, catalysts from the group consisting of tin carboxylates are used. Very particular preference is here given to tin 2-ethylhexanoate and tin ricinoleate. Tin 2-ethylhexanoate is of particular importance for the production of a flexible PU foam according to the invention. Particular preference is also given to the use of trimerization catalysts such as potassium 2-ethylhexanoate and potassium acetate. Preference is also given to tin compounds having completely or partly covalently bound organic radicals. Particular preference is here given to using dibutyltin dilaurate.

In a further embodiment, the object of the invention is achieved by a system for carrying out the above-described process, which comprises, as separate individual components, at least
a) an above-defined nucleating agent,
b) a diisocyanate, and
c) a polyol together with the other constituents necessary for the production of the polyurethane foam.

The proportion by weight of the individual component of the nucleating agent of the invention, based on all individual components together, is preferably in the range from about 0.01 to about 5% by weight, in particular from about 0.2 to about 1% by weight.

Industrially, the nucleating agent of the invention can be employed in the various processing systems known to those skilled in the art. A comprehensive overview is given in G. Oertel (Editor): “Kunststoff-Handbuch”, volume VII, Carl Hanser Verlag, 3rd edition, Munich 1993, pp. 139-192, and in D. Randall and S. Lee (both Editors): “The polyurethanes Book” J. Wiley, 1st edition, 2002. In particular, the nucleating agent of the invention can be used in high-pressure machines. In a further application, the nanoparticle dispersion can be used in low-pressure machines. The nucleating agent can be introduced separately into the mixing chamber. In a further process variant, the nucleating agent of the invention can be mixed into one of the components which is to be fed into the mixing chamber before it enters the mixing chamber. Mixing with the water added for foaming or the polyol is particularly advantageous. Mixing can also be carried out in the raw materials tank.

The plant for producing the polyurethane foam can be carried out continuously or batchwise. The use of the nucleating agent of the invention for continuous foaming is particularly advantageous. Here, the foaming process can occur either in a horizontal direction or in a vertical direction. In a further embodiment, the nanoparticle dispersion according to the invention can be utilized for the CO₂ technology. Here, the nanoparticle dispersion is particularly advantageous for the very rapid nucleation. The nucleating agent of the invention is also particularly suitable for loading of the reaction products with other gases.

In a further embodiment, foaming can also be effected in molds.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 compares directly the effect of calcium carbonate powder (micro meter sized) with the nanoparticle dispersion on the cell size of the resulting PU foam.

FIG. 2 is identical to FIG. 1 with the exception, that the x-axis displays the total share of the nucleating additive within the foam formulation (by weight).

FIG. 3 and FIG. 4 are similar to FIG. 1 and 2, respectively, but the cell count is based on electronic cell detection software.

FIG. 5 provides the particle size information of the nanoparticle dispersion described in Example 5.

The invention is further described by the following non-limiting examples which further illustrate the invention, and are not intended, nor should they be interpreted to, limit the scope of the invention.

### EXAMPLES

The following materials were used:

Characterization of the nanoparticles used:
Alu 1: basic aluminum oxide, primary particles: <20 nm, manufacturer: Degussa
Alu C: neutral aluminum oxide, primary particles: about 13 nm, manufacturer: Degussa (cf. FIG. 6 in agglomerate in water).
Aerosil® Ox 50: silicon dioxide, primary particles: about 40 to 50 nm, manufacturer: Degussa
ZnO 20: unmodified hydrophilic zinc oxide, primary particles: <50 nm, manufacturer: Degussa

Characterization of the dispersants used:
Tego® Dispers 752 W: maleic anhydride copolymer having a comb structure from Tego Chemie Service GmbH.
Tego® Dispers 650: polyether based on styrene oxide from Tego Chemie Service GmbH
VP-D-102: alkoxy-alkyl quat from Tego Chemie Service GmbH

Characterization of the calcium carbonate used:

Calcium carbonate, precipitated, analytical reagent, mean particle size: 1 to 2 microns, manufacturer: Fluka

Characterization of the polymer polyol Voralux® HL 106 used: styrene-acrylonitrile polymerpolyol from DOW, OHN =44

General Formulation for the Production of the Experimental Flexible PU Foams:
100 parts by weight of polyol (Desmophen® PU70RE30 from Bayer, OH-No. 56)
4.0 parts by weight of water (chemical blowing agent) (in the case of the nanoparticle dispersions with water as solvent, correspondingly less water is used here)
1.0 part by weight of PU foam stabilizer (Tegostab® BF 2370 from Goldschmidt GmbH)
0.15 part by weight of catalyst for blowing reaction (dimethylethanolamine)
0.2 part by weight of catalyst for gelling reaction (Kosmos® 29, corresponds to tin 2-ethylhexanoate)
x parts by weight of the above-defined nucleating agent (nanoparticle dispersion)/(microparticle dispersion)
49.8 parts by weight of isocyanate (tolylene diisocyanate, TDI-80, Index: <105>)

Amount used [% of the total formulation] =parts by weight of nanoparticle dispersion ×100/total mass of the formulation

Procedure:

Polyol, water, catalysts, stabilizer and optionally the nanoparticle dispersion were placed in a cardboard cup and mixed by means of a Meiser disk (60 s at 1000 rpm). The isocyanate (TDI-80) was subsequently added and the mixture was stirred again at 1500 rpm for 7 s. The mixture was then introduced into a box (30 cm×30 cm×30 cm). During foaming, the rise height was measured by means of an ultrasound height measurement. The full rise time is the time which elapses until the foam has reached its maximum rise height. The settling refers to the extent to which the foam sinks back after blowing-off of the PU foam. The settling is measured 3 minutes after blowing-off as a fraction of the maximum rise height. The gas permeability was measured by the pressure buildup method.

Examples in detail:

### Comparative Example 1

### Experiment without Nanoparticles

Full rise time: 117 s

Settling: +0.3 cm

Rise height: 29.0 cm

Density of the foam: 24.4 kg/m³

Gas permeability: 2.4 cm of ethanol

Cell count (counted manually): 8-9 cm⁻¹

Cell count (counted automatically with the aid of cell recognition software): 10.1 cm⁻¹

Elongation at break: 188%

Tensile stress at break: 100 kPa

Compression set (90%): −5%

Compressive strength (40%): 3.1 kPa

### Comparative Example 2

### Experiment using only an Aqueous Solution of the Dispersants Tego® Dispers 752 W, 1.0 part by weight (4.5% of Tego® Dispers 752W in Water)

Full rise time: 122 s

Settling: +0.0 cm

Rise height: 29.5 cm

Density of the foam: 24.0 kg/m³

Gas permeability: 2.5 cm of ethanol

Cell count (counted manually): 11 cm⁻¹

Cell count (counted automatically with the aid of cell recognition software): 10.8 cm⁻¹

Elongation at break: 181%

Tensile stress at break: 102 kPa

Compression set (90%): −5%

Compressive strength (40%): 3.1 kPa

### Comparative Example 3

### Experiment using only the Dispersant Tego® Dispers 650, 1.0 Part (100% Tego® Dispers 650)

Full rise time: 123 s

Settling: +0.0 cm

Rise height: 30.0 cm

Density of the foam: 24.1 kg/m³

Gas permeability: 3.2 cm of ethanol

Cell count (counted manually) : 10 cm⁻¹

Cell count (counted automatically with the aid of cell recognition software) : 11.6 cm⁻¹

Elongation at break: 181%

Tensile stress at break: 95 kPa

Compression set (90%): −5%

Compressive strength (40%): 3.2 kPa

### Comparative Example 4

### Experiment using Calcium Carbonate, 1.0 Part by Weight (Fluka 21060, 30% by Weight in Polyol Desmophen® PU70RE30)

Full rise time: 120 s

Settling: +0.0 cm

Rise height: 29.8 cm

Density of the foam: 24.0 kg/m³

Gas permeability: 3.1 cm of ethanol

Cell count (counted manually): 11 cm⁻¹

Cell count (counted automatically with the aid of cell recognition software) : 12 cm⁻¹

Elongation at break: 139%

Tensile stress at break: 95 kPa

Compression set (90%): −4%

Compressive strength (40%): 3.7 kPa

### Comparative Example 5

### Experiment using Polymer Polyol Voralux® HL 106, 1.0 part by Weight

Full rise time: 119 s

Settling: +0.0 cm

Rise height: 29.9 cm

Density of the foam: 24.2 kg/m³

Gas permeability: 3.6 cm of ethanol

Cell count (counted manually): 8 cm⁻¹

Cell count (counted automatically with the aid of cell recognition software): 11 cm⁻¹

Elongation at break: 176%

Tensile stress at break: 94 kPa

Compression set (90%): −5%

Compressive strength (40%): 3.0 kPa

### Comparative Example 6

### Experiment using EMIM ES, 1.0 part

Full rise time: 118 s

Settling: +0.1 cm

Rise height: 29.6 cm

Density of the foam: 24.75 kg/m³

Gas permeability: 1.1 cm of ethanol

Cell count (counted manually): 12 cm⁻¹

Cell count (counted automatically with the aid of cell recognition software): 12.8 cm⁻¹

Elongation at break: 161%

Tensile stress at break: 103 kPa

Compression set (90%): −5%

Compressive strength (40%): 3.6 kPa

### Comparative Example 7

### Experiment using VP-D 102, 1.0 Part

Full rise time: 114 s

Settling: 0 cm

Rise height: 30.0 cm

Density of the foam: 24.55 kg/m³

Gas permeability: 1.0 cm of ethanol

Cell count (counted manually): 12 cm⁻¹

Cell count (counted automatically with the aid of cell recognition software): 11.9 cm⁻¹

Elongation at break: 156%

Tensile stress at break: 94 kPa

Compression set (90%): −5%

Compressive strength (40%): 3.4 kPa

### Example 1

1.0 part by weight of [Alu C nanoparticles (15% by weight)+EMIM ES (85% by weight; ionic liquid together with dispersant)]

Full rise time: 123 s

Settling: +0.4 cm

Rise height: 27.5 cm

Density of the foam: 27.2 kg/m³

Gas permeability: 2.4 cm of ethanol

Cell count (counted manually): 16-17 cm⁻¹

Cell count (counted automatically with the aid of cell recognition software): 17.5 cm¹

Elongation at break: 100%

Tensile stress at break: 79 kPa

Compression set (90%): −5%

Compressive strength (40%): 3.1 kPa

### Example 2

1.0 part by weight of [Alu 1 nanoparticles (30% by weight) +Tego® Dispers 752W (4.5% by weight) (dispersant) +water (65.5% by weight) (solvent)]

Full rise time: 116 s

Settling: +0.1 cm

Rise height: 29.8 cm

Density of the foam: 24.1 kg/m³

Gas permeability: 0.9 cm of ethanol

Cell count (counted manually): 16-17 cm⁻¹

Cell count (counted automatically with the aid of cell recognition software): 17.2 cm⁻¹

Elongation at break: 155%

Tensile stress at break: 92 kPa

Compression set (90%): −5%

Compressive strength (40%): 3.2 kPa

### Example 3

1.0 part by weight of [zinc oxide nanoparticles (30% by weight) +VP-D102 (70% by weight) (dispersant)]

Full rise time: 110 s

Settling: +0.4 cm

Rise height: 27.2 cm

Density of the foam: 27.8 kg/m³

Gas permeability: 1.9 cm of ethanol

Cell count (counted manually): 17-18 cm⁻¹

Cell count (counted automatically with the aid of cell recognition software): 18.2 cm⁻¹

Elongation at break: 100%

Tensile stress at break: 82 kPa

Compression set (90%): −5%

Compressive strength (40%): 3.2 kPa

### Example 4

1.0 part by weight of [Aerosil® Ox 50 (silicon dioxide) nanoparticles (30% by weight) +Tego® Dispers 650 (70% by weight) (dispersant)]

Full rise time: 115 s

Settling: +0.3 cm

Rise height: 27.1 cm

Density of the foam: 27.4 kg/m³

Gas permeability: 1.4 cm of ethanol

Cell count (counted manually): 17-18 cm⁻¹

Cell count (counted automatically with the aid of cell recognition software: 17.5 cm⁻¹

Elongation at break: 96%

Tensile stress at break: 76 kPa

Compression set (90%): −5%

Compressive strength (40%): 3.1 kPa

### Example 5

### Concentration Series using Nanoparticle Dispersion

(Aerosil® Ox 50 (30% by weight) +Tego® Dispers 752W (4.5% by weight) +65.5% by weight of water)

| | | | | | | |
|---|---|---|---|---|---|---|
| Amount of nanoparticle dispersion (30% by weight) | 0.0 | 0.01 | 0.1 | 0.25 | 0.5 | 1.0 |
| used [parts based on 100 parts of polyol] | | | | | | |
| Amount of nanoparticle dispersion (30% by weight) | 0.0 | 0.0065 | 0.065 | 0.16 | 0.32 | 0.64 |
| used [% by weight of the mass of the foam] | | | | | | |
| Amount of pure nanoparticles used | 0.0 | 0.002 | 0.02 | 0.048 | 0.096 | 0.19 |
| [% by weight of the mass of the foam] | | | | | | |
| Full rise time [s] | 114 | 112 | 115 | 118 | 120 | 120 |
| Settling [cm] | +0.1 | +0.1 | 0 | 0 | 0 | 0 |
| Rise height [cm] | 29.3 | 29.6 | 29.5 | 29.7 | 30.2 | 29.4 |
| Gas permeability [cm of ethanol] | 5.4 | 5.0 | 5.1 | 4.0 | 4.0 | 3.1 |
| Cell count (counted manually) [cm⁻¹] | 9 | 9 | 9 | 10 | 14 | 15 |
| Cell count (counted automatically with the | 9.3 | 9.8 | 9.9 | 11.2 | 13.0 | 13.9 |
| aid of cell recognition software) [cm⁻¹] | | | | | | |

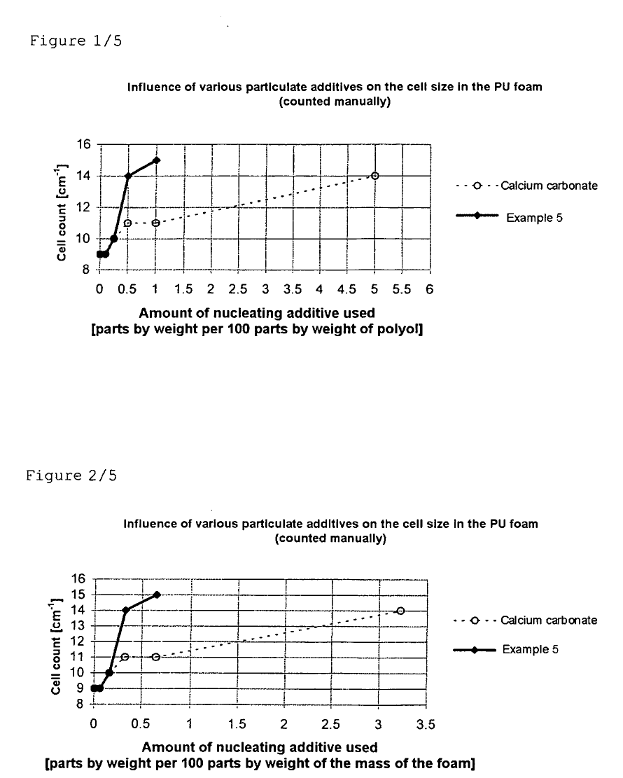

FIG. 1 compares directly the effect of calcium carbonate powder (micro meter sized) with the nanoparticle dispersion on the cell size of the resulting PU foam. The exact data of the foaming experiments done with the addition of calcium carbonate are summarized in Example 6 below. The data of the foaming experiments with added nanaparticle dispersion are described in Example 5. The x-axis displays the amount of nucleating agent in comparison to 100 parts per weight polyol. This scaling is well established in PU industry. The amount of cells per cm has been determined by manual counting, which means that a experienced person uses a magnifying glass and a scale to count the cells along a line on the foam surface.

FIG. 2 is identical to FIG. 1 with the exception, that the x-axis displays the total share of the nucleating additive within the foam formulation (by weight). This scaling is more widespread in the art.

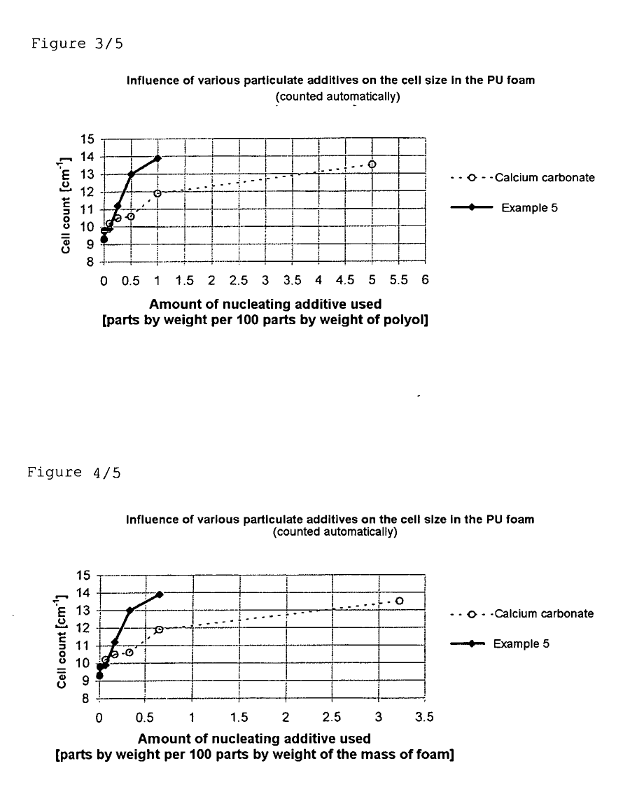

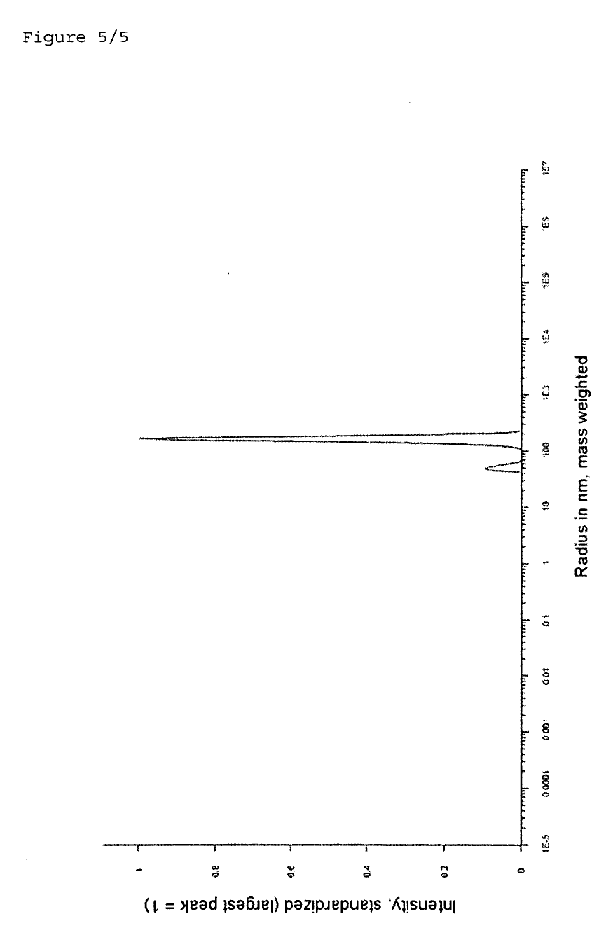

FIG. 3 and FIG. 4 also refer to Examples 5 and 6. In contrast to FIG. 1 and 2 is the cell count now based on an electronic cell detection software, which has been introduced recently (Conference Paper, R. Landers, J. Venzmer, T. Boinowitz, Methods for Cell Structure Analysis of Polyurethane Foams, Polyurethanes 2005, Technical Conference, Houston, Tex., Oct. 17-19, 2005). This mean value is the result after counting several thousands of cells automatically. Again, like with FIG. 1 and 2, both types of x-axis scaling are displayed. FIGS. 1-4 indicate the high nucleating efficiency of the described nanoparticle dispersion. FIG. 5 provides the particle size information of the nanoparticle dispersion described in Example 5. The cell size distribution is the result of a state-of-the-art dynamic light scattering experiment. The resulting distribution is mass weighted. Two peaks are visible. The dominating part of the particles has a size of 100-200 nm. A smaller fraction has a size between 40 and 70 nm.

### Example 6

### Concentration Series using Pure Calcium Carbonate Microparticles

| | | | | | | | |
|---|---|---|---|---|---|---|---|
| Amount of pure calcium carbonate (microparticles) | 0.0 | 0.01 | 0.1 | 0.25 | 0.5 | 1.0 | 5.0 |
| used [parts based on 100 parts of polyols] | | | | | | | |
| Amount of pure calcium carbonate (microparticles) | 0.0 | 0.0065 | 0.065 | 0.16 | 0.32 | 0.64 | 3.1 |
| used [% by weight of the mass of the foam] | | | | | | | |
| Full rise time [s] | 114 | 112 | 114 | 115 | 114 | 118 | 120 |
| Settling [cm] | +0.1 | 0.0 | 0.0 | 0.0 | 0.0 | 0.0 | 0.0 |
| Rise height [cm] | 29.3 | 29.7 | 29.5 | 29.5 | 30.0 | 30.0 | 29.8 |
| Gas permeability [cm of ethanol] | 5.4 | 5.0 | 5.8 | 4.4 | 4.0 | 3.7 | 3.2 |
| Cell count (counted manually) [cm⁻¹] | 9 | 9 | 9 | 10 | 11 | 11 | 14 |
| Cell count (counted automatically with the | 9.3 | 9.8 | 10.2 | 10.5 | 10.6 | 11.9 | 13.5 |
| aid of cell recognition software) [cm⁻¹] | | | | | | | |

General formulation for rigid PU foam

For the following comparison, rigid foams were produced in a closable metallic mold which had dimensions of 145 cm×14 cm×3.5 cm and was heated to 45° C. by manual foaming of a polyurethane formulation having the following constituents:

100.00 parts of sorbitol/glycerol-based polyether polyol (460 mg KOH/g)

2.60 parts of water

1.50 parts of dimethylcyclohexylamine

2.0 parts of stabilizer B 8462

15.00 parts of cyclopentane

198.50 parts of diphenylmethane diisocyanate, isomers and homologues isocyanate content: 31.5%)

The rigid foams obtained were counted visually by means of a microscope.

### Comparative Example 8

### Rigid foam without nanoparticle dispersion

Density of the foam: 33 kg/m³

Thermal conductivity: 23.8 mW/mK

Cell count (counted manually): 30 cm®

### Example 7

### Rigid Foam with Nanoparticle Dispersion

(nanoparticles Alu C (30% by weight) +Tego® Dispers 752W (4.5% by weight) +65.5% by weight of water)

Density of the foam: 33 kg/m³

Thermal conductivity: 22.9 mW/mK

Cell count (counted manually): 45 cm®

Having thus described in detail preferred embodiments of the invention, it is to be understood that the invention defined by the appended claims is not to be limited to particular details set forth in the above description as many apparent variations thereof are possible without departing from the spirit or scope of the invention. Thus, it is intended that the present invention covers the modifications and variations of this invention that come within the scope of any claims and their equivalents.

1. A nucleating agent for the production of polyurethane foam, which comprises
a) from about 0.5 to about 60% by weight of nanoparticles having an average diameter in the range from about 1 to about 400 nm,
b) from about 0.5 to about 99.5% by weight of dispersant, and
c) from 0 to about 99% by weight of solvent,
in each case based on the total amount of the nucleating agent.

2. The nucleating agent as claimed in claim 1, wherein the diameter of the nanoparticles is in the range from about 10 to about 200 nm.

3. The nucleating agent as claimed in claim 1, wherein the proportion of dispersant is in the range from about 1 to about 45% by weight.

4. The nucleating agent as claimed in claim 1, wherein the proportion of nanoparticles is in the range from about 25 to about 35% by weight.

5. The nucleating agent as claimed in claim 1, wherein the nanoparticles comprise metal oxide.

6. The nucleating agent as claimed in claim 1 which is free of PU foam stabilizer.

7. A polyurethane foam which has a cell count of at least about 10 cm⁻¹ and contains from about 0.01 to about 5% by weight of nanoparticles having an average diameter in the range from about 1 to about 400 nm.

8. The polyurethane foam as claimed in claim 7 which has a cell count of at least about 15 cm⁻¹.

9. The polyurethane foam as claimed in claim 7 which is a flexible foam, a rigid foam or a microcellular foam.

10. The polyurethane foam as claimed in claim 7 which has a density in the range from about 10 to about 80 kg/m³.

11. The polyurethane foam as claimed in claim 7 which has a gas permeability in the range from about 0.1 to about 30 cm of ethanol.

12. The polyurethane foam as claimed in claim 7 which has a proportion of nanoparticles in the range from about 0.01 to about 5% by weight.

13. A method of controlling the cell structure of polyurethane foam, which comprises:
adding from about 0.01 to about 5% by weight of the nucleating agent as claimed in claim 1, based on the total amount of the polyurethane foam, before the addition of diisocyanate in the production process for polyurethane foam,
wherein the cell structure being controlled essentially by means of the amount of nucleating agent, the amount of dispersant in the nucleating agent and the amount and diameter of the nanoparticles in the nucleating agent.

14. The method of controlling the cell structure as claimed in claim 13, wherein the nucleating agent is added in an amount of from about 0.15 to about 4% by weight.

15. A process for producing PU foam, which comprises:
a) mixing of 100 parts by weight of polyol, from about 0.2 to about 5 parts by weight of chemical blowing agent, from about 0.1 to about 5 parts by weight of stabilizer and from about 0.01 to about 5 parts by weight of nucleating agent as claimed in claim 1,
b) addition of from about 30 to about 70 parts by weight of a diisocyanate, and
c) mixing of the resulting composition.

16. The process for producing PU foam as claimed in claim 15, wherein from about 0.5 to about 1.5 parts by weight.

17. A system for carrying out the process as claimed in claim 14, which comprises, as separate individual components, at least
a) a nucleating agent as claimed in claim 1,
b) a diisocyanate, and
c) a polyol together with the other constituents necessary for the production of the polyurethane foam.

18. The system as claimed in claim 17, wherein the weight of the component of the nucleating agent makes up a proportion in the range from about 0.01 to about 5% by weight.

19. The nucleating agent of claim 1, wherein:
(a) the diameter of the nanoparticles is in the range from about 10 to about 50 nm;
(b) the proportion of dispersant is in the range of about 2 to about 10% by weight;
(c) the nanoparticles comprise metal oxide selected from the group consisting of SiO₂, ZnO₂, Al₂O₃, ZrO₂ and TiO₂; and
(d) said nucleating agent is free of PU foam stabilizer.

20. The polyurethane foam of claim 7, wherein said foam:
(a) has a density of about 15 to about 50 kg/m³;
(b) has a gas permeability in the range of about 0.7 to about 10 cm of ethanol; and
(c) has a proportion of nanoparticles in the range of from about 0.24 to 0.80% by weight.
